(19) United States
(12) Patent Application Publication
(10) Pub. No.: US 2006/0181790 A1
(43) Pub. Date: Aug. 17, 2006

(54) Rearview mirror system

(76) Inventor: Harry C. Jones III, Washington, DC (US)

Correspondence Address: WINSTON & STRAWN LLP, 1700 K STREET, N.W., WASHINGTON, DC, 20006, US

(21) Appl. No.: 11/059,365

(22) Filed: Feb. 17, 2005

(51) Int. Cl. G02B 7/182

(52) U.S. Cl. 359/843; 359/877

(57) ABSTRACT

A vehicle rearview mirror system including a sweep mirror movable back and forth between a home position to an extended position. In the home position the driver views the normal rearview area while in the extended position the driver views the blind area into which another vehicle passing from behind enters after moving out of the normal viewing area of the mirror. The sweep mirror is moved to its extended position by a high speed motor controlled by the driver. The control is preferably included as part of the turn signal mechanism of the vehicle. Movement of the turn signal lever to actuate operation of the turn signal also activates the motor for the sweep mirror to move it quickly to its extended position.

### BACKGROUND OF THE INVENTION

The invention relates to a vehicle mirror system and more particularly to a rearview mirror system for viewing two different areas behind the vehicle. In presently constructed rearview mirrors, a mirror is typically mounted on each side of the vehicle for use by the driver. A third mirror is included in vehicles having a back window. The third mirror is mounted at the top center of the windshield. All of these mirrors are adjustable by the driver about both horizontal and vertical pivot axes so that once set to a home position, the driver is able to view the area generally behind the vehicle. With these mirrors mounted in a vehicle there is, however, a blind spot or area which is not readily viewable by way of the mirrors, once set in the home position. This blind spot is an area in which another vehicle would enter upon passing a first vehicle. The blind area starts as the second vehicle gets close enough behind and to the side of the first vehicle so as to no longer be visible in the mirrors of the first vehicle and ends when the second vehicle is viewable directly by the driver as the second vehicle gets to a location nearly broadside of the first vehicle.

When the driver of the first vehicle wants to change the lane the vehicle is in, as, for example, to pass a vehicle in front of the first vehicle, this blind area is a danger since it is not readily known if another vehicle is in this blind area. Usually the driver leans forward to change the viewing area in the appropriate mirror to include at least part of the blind area. More typically, the driver must turn his head and look directly out of the front and rear side window to see if any vehicle is in the blind area.

Although the standard side mounted mirror in today's vehicles may be adjusted about its pivot axes by activating a drive mechanism to at least partially view the blind area, the resulting movement of the mirror is too slow, about four or five seconds, to be of any use when the driver needs to quickly determine if it is safe to change lanes on the road or highway. Furthermore, the control for the standard drive mechanism of the side mounted mirrors is not positioned for ready access without detracting the driver from driving.

### BRIEF SUMMARY OF THE INVENTION

The present invention provides a quick and reliable way to view the blind area without the driver having to lean forward to change his viewing angle through the side mounted mirror and without having to turn to the side to get a direct view of the blind area. The present invention includes a mirror system in which the mirror is set to a first home position to enable the driver to view a first area generally directly behind the vehicle and is quickly movable to a second extended position which will provide a view of the blind area.

The movement of the mirror to the extended position is effected by a high speed drive mechanism which moves the mirror from its home position to its extended position in about a second or fraction of a second or at whatever speed is necessary to give the driver adequate knowledge of the presence of any vehicle in the blind area.

A first embodiment the mirror system of the present invention includes one mirror for viewing the area generally directly behind the vehicle and a second sweep mirror quickly movable in a horizontal sweep motion from a home position for viewing the first area and an extended position for viewing the blind area. The two mirrors are mounted adjacent to each other so as to appear as a single mirror when viewing the first area and are connected to appropriate drive mechanisms to effect their desired movement. In another embodiment, a single sweep mirror is provided with two drives, one for the normal adjustment of the mirror and another for quickly moving the mirror in a horizontal sweep motion from its home position to its extended position.

In both embodiments, the presently preferred control for the drive mechanism for moving the mirror from its home position to its extended position is incorporated into the standard turn signal mechanism. More particularly, movement of the standard turn signal lever in a direction to initiate actuation of the vehicle's turn signal flasher will cause the mirror to cycle to its extended position, and movement of the turn signal lever in a direction back towards its normal standby position will cause the mirror to cycle back to its home position.

### BRIEF DESCRIPTION OF THE DRAWINGS

FIG. 1 is a schematic view of one vehicle passing a vehicle using the mirror system of the present invention;

FIG. 2 is another schematic view showing a passing vehicle on the opposite side and at a different spacing from the vehicles shown in FIG. 1;

FIG. 3 is a front view of a first embodiment of the mirror system of the present invention;

FIG. 4 is a top view, partially broken away and in partial cross-section, of the first embodiment of the mirror system;

FIG. 5 is a back view, partially broken away and in partial cross-section, of the first embodiment of the mirror system;

FIG. 6 is a cross-sectional view taken along lines 6-6 of FIG. 4;

FIG. 7 is a cross-sectional view taken along lines 7-7 of FIG. 4;

FIG. 8 is a cross-sectional view taken along lines 8-8 of FIG. 6;

FIG. 9 is a schematic view showing the control and operating drive mechanism of the mirror system of the present invention;

FIG. 10 is a schematic view showing the mirror system of the present invention incorporated with the standard drive mechanism for adjusting the mirror;

FIG. 11 is schematic view showing the electrical switching for the motor controlling the horizontal sweep movement of the mirror system of the present invention;

FIG. 12 is a cross-sectional view, on an enlarged scale, taken along lines 12-12 of FIG. 9;

FIG. 13 is a cross-sectional view taken along lines 13-13 of FIG. 12;

FIG. 14 is a vertical cross-sectional view, on an enlarged scale, of one of the electrical contacts shown in FIG. 9;

FIG. 15 is a cross-sectional view taken along lines 15-15 of FIG. 12;

FIG. 16 is a back view, similar to FIG. 5, partially broken away and in partial cross-section, of a second embodiment of the present invention;

FIG. 17 is a cross-sectional view, similar to FIGS. 6 and 7, of the second embodiment of the invention; and

FIG. 18 is a cross-sectional view, similar to FIGS. 6 and 7, of a third embodiment of the invention.

### DETAILED DESCRIPTION OF THE INVENTION

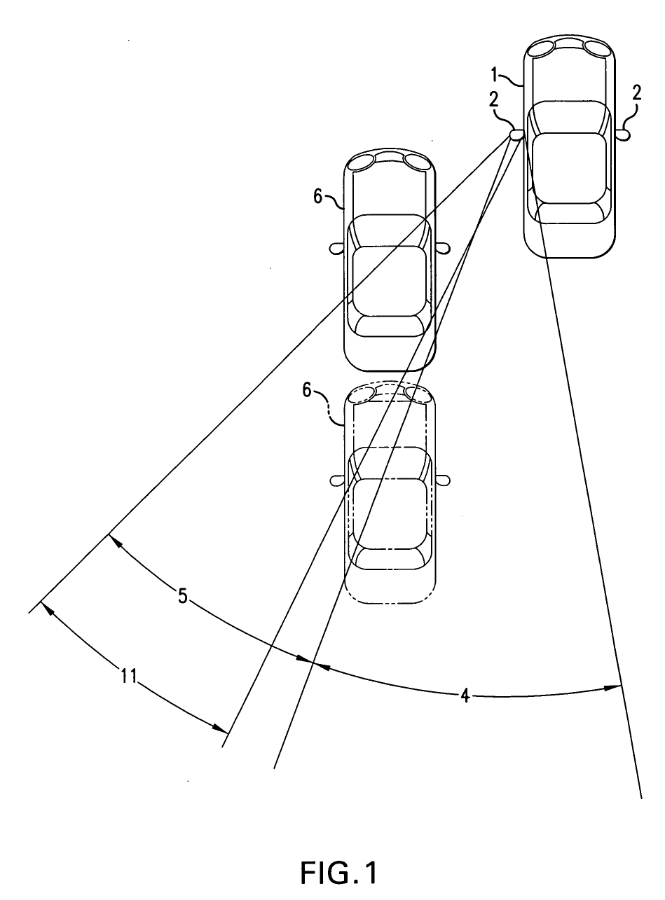

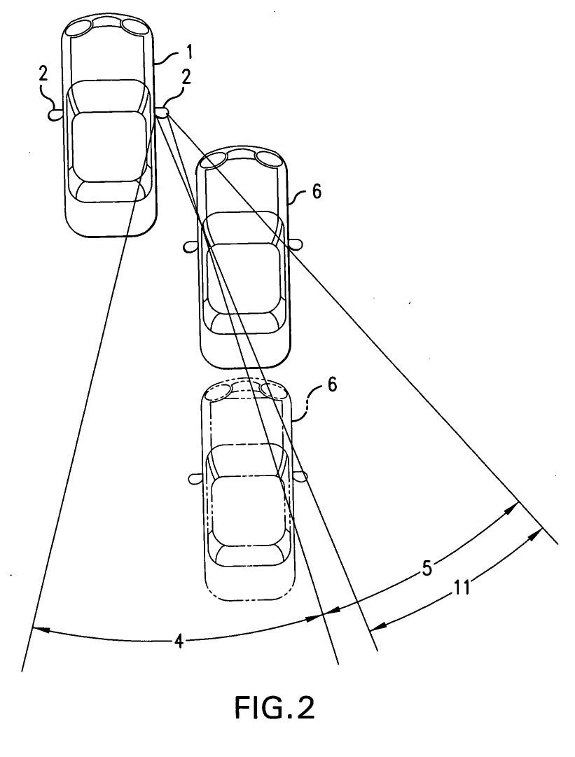

As shown in FIGS. 1 and 2, a first vehicle 1 with side-mounted rearview mirror structures 2, has a normal viewing area 4 and a blind area 5. The normal viewing area is shown in FIG. 1 for the side-mounted rearview mirror structure 2 on the driver's side of the vehicle and in FIG. 2 for the passenger side mirror structure. The normal view through use of the mirror structures 2 is generally behind the first vehicle 1. The blind spot or area 5, on the other hand, generally includes an area in which a second vehicle 6 would enter when passing the first vehicle from behind. The blind area starts as the second vehicle moves from the phantom position shown in FIGS. 1 and 2 and gets close enough behind and to the side of the first vehicle so as to no longer be readily viewable in either of the mirrors 2, depending on which side the second vehicle is passing. The blind area ends when the second vehicle is viewable directly by the driver, which is generally when the second vehicle gets nearly broadside of the first vehicle or, more particularly, as the front end of the second vehicle gets broadside to the driver.

In FIG. 1, the second vehicle is shown as passing on the driver's side of the vehicle with lateral spacing between the two vehicles about equal to the width of the vehicles. FIG. 2 shows a passing vehicle on the passenger side of the first vehicle and with a smaller lateral spacing between the two vehicles. For clarity, the mirror viewing area and blind area have been shown for only one side of the vehicle in FIG. 1 and FIG. 2 and the angles which define the viewing area 4 and blind area 5 have been shown as approximate. They will vary with different model vehicles, with different drivers and with different driver seat positioning.

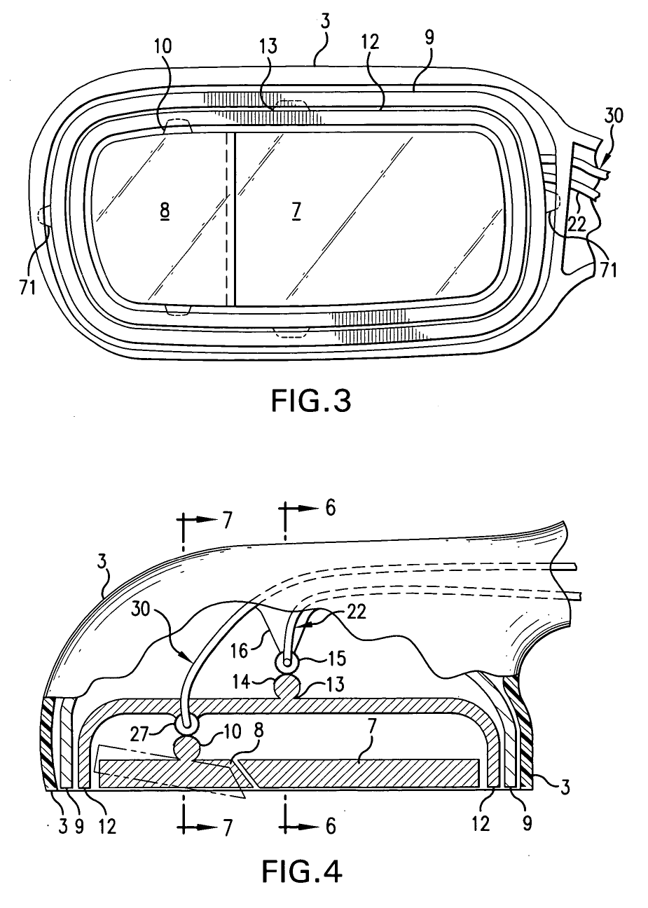

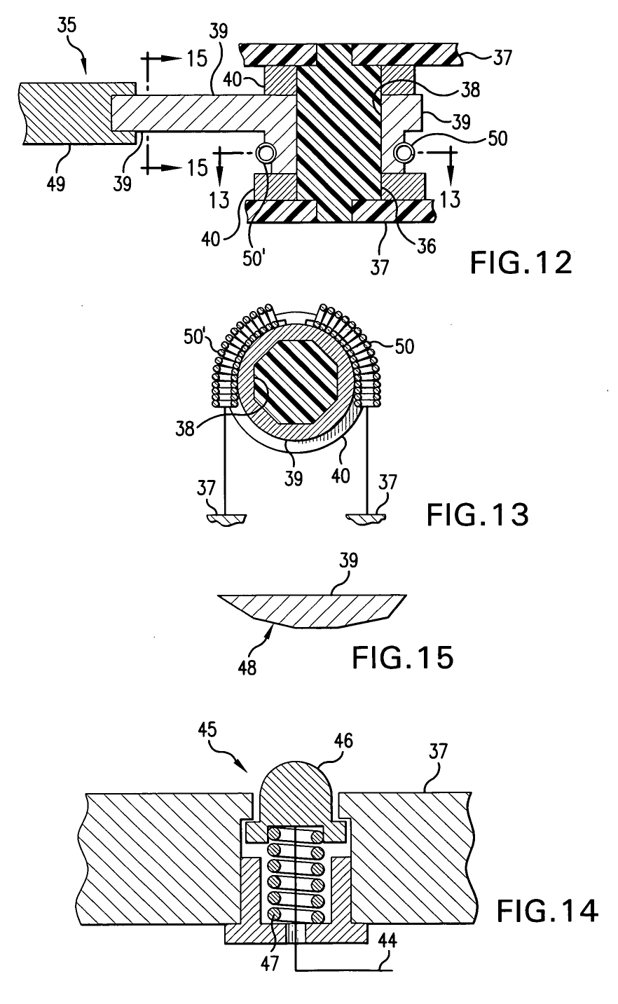

In accordance with the teachings of the present invention, one embodiment of the mirror system, as shown in FIGS. 3-15, includes a pair of mirrors 7 and 8 contained in a single rearview frame assembly 9. This mirror assembly is insertable into the outer housing 3 of either of the mirror structures 2 of the vehicle 1. In the drawings the assembly replacement for the driver's side mirror 2 is shown. It is to be understood, however, that the assembly replacement for the mirror structure on the passenger side would be the mirror image of that shown in the drawings.

The first mirror 7 of the mirror system is a rearview mirror mounted in a location for a driver of the first vehicle 1 to see the normal viewing area 4. The second sweep mirror 8 of the mirror system is mounted in the mirror assembly 9 immediately horizontally adjacent to the first mirror 7.

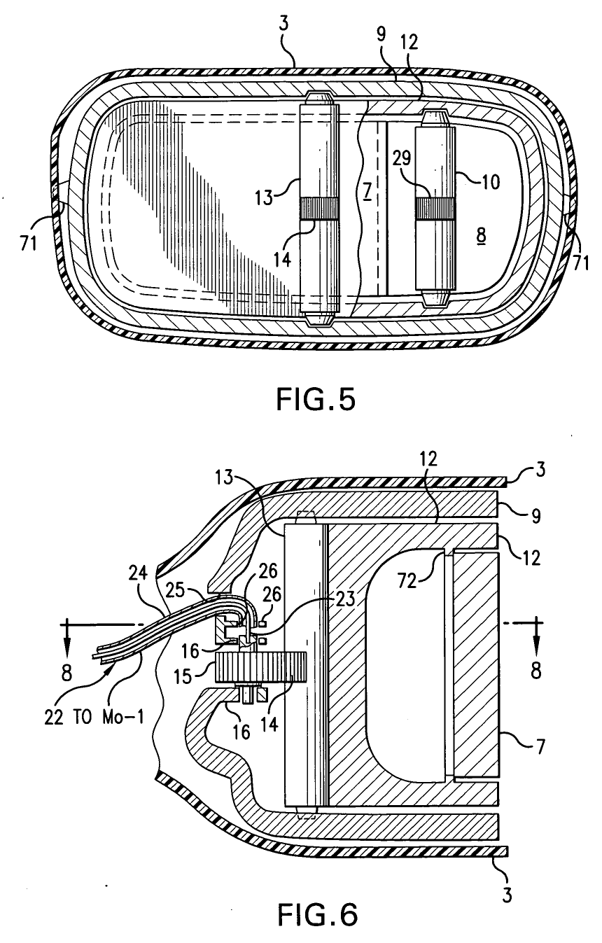

As with a conventional rearview mirror, the mirror 7 is movably adjustable about both a horizontal and a vertical axis by means of a drive mechanism. Movement about the horizontal axis to vertically adjust the normal viewing area 4 is provided by rotatably mounting the mirror assembly 9 in the housing 3 of the mirror structure 2. More particularly and as shown in FIG. 5, the assembly 9 includes two horizontally extending bearing posts 71, one at each lateral end of the assembly 9. These posts are rotabably mounted in the housing 3 of the mirror structure 2. In this way the entire mirror assembly 9 with both mirrors 7 and 8 can be rotated or tilted back and forth by pivoting the assembly about the horizontal axis of the posts 71. This, in turn, is accomplished by operating a conventional drive mechanism provided for this purpose. The drive mechanism can either be a manual mechanically connected drive or a motorized drive operated by a control on the driver's door or door frame of the first vehicle.

The mirrors 7 and 8 are adjustable about their vertical and horizontal axes for purposes of setting them in the best home position for any particular driver of the first vehicle to properly view area 4. When in this position, the second sweep mirror 8 will normally extend in the same plane as the first mirror 7 and thus also provide a view of area 4. This position of mirrors 7 and 8 is shown in solid lines in FIGS. 3 and 4. In accordance with the present invention, however, the second sweep mirror 8 is pivotally mounted in the mirror assembly 9 for rotative movement about a vertical axis relative to the first mirror 7, between a home position and an extended position. The home position is one in which it is in the same plane as the first mirror and is shown in solid lines in FIG. 4. The extended position is one in which it has been rotated or pivoted about its vertical mounting post 10 to the dotted line position shown in FIG. 4. The adjacent edges of the two mirrors 7 and 8 are complimentarily chamfered, as shown in FIG. 4, to facilitate relative movement.

In the extended position of the second sweep mirror 8, the driver has a view of the blind area 5 or at least the major critical portion of this area. As an example, measurements were taken for a 2002 BMW™, 3-series 330ci vehicle with a six-foot driver and with the driver's seat positioned low and about one-third of the way back. With the mirror system on the driver's side of the vehicle, the normal viewing area 4 included an angle of about 25° and the viewable blind area 11 included an angle of about 17°. This viewable blind area 11 was estimated by moving the standard side mounted single mirror until most of the blind area 5 could be viewed. With the drive mechanism for this vehicle, this movement took about 4 or 5 seconds.

The normal viewing area 4 and viewable blind area 11 are shown in FIGS. 1 and 2 as overlapping immediately adjacent the first vehicle and as being somewhat spaced from each other at a distance rearward of the first vehicle. With different vehicles and different mirrors and driver positions, these two areas 4 and 11 may be oriented differently relative to each other. In particular they may overlap over the entire viewing areas and the area 11 may extend further outwardly of the first vehicle. Also, the mirrors 7 and 8 can be specifically constructed so as to provide the optimum view of the areas 4 and 5 for any particular vehicle.

Further, it is to be understood that combined pivoting of the sweep mirror 8 about the vertical axis of post 10 and the horizontal axis of the mounting posts 71 of the entire assembly 9 may also be appropriate when moving the mirror 8 to its extended position and is within the scope of the present invention. It is believed, however, that pivoting of the mirror 8 only about the vertical axis of its mounting post 10 is generally sufficient to bring the blind area into view. Accordingly, the following description of all embodiments of the invention is generally limited to the constructions for pivoting the mirrors about the vertical axis.

In FIGS. 3-7, the mirrors 7 and 8 are shown as mounted together in the mirror assembly 9 by way of a subframe 12. Specifically, the mirror 7 is fixedly mounted to a flange support 72 of the subframe 12 by adhesive or other suitable means. The mirror 8, on the other hand, is rotatably mounted in the subframe 12 by way of its mounting post 10.

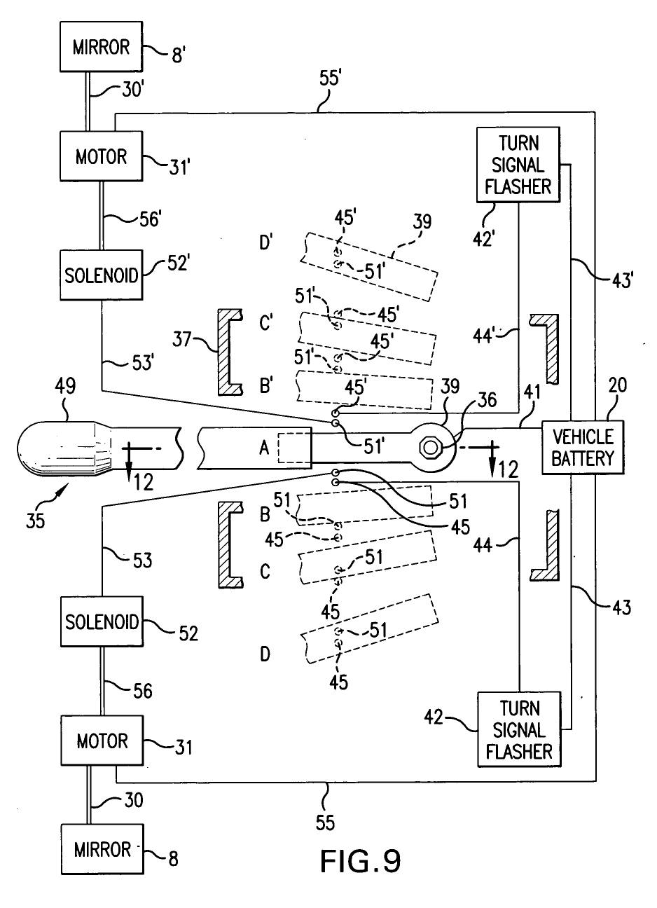

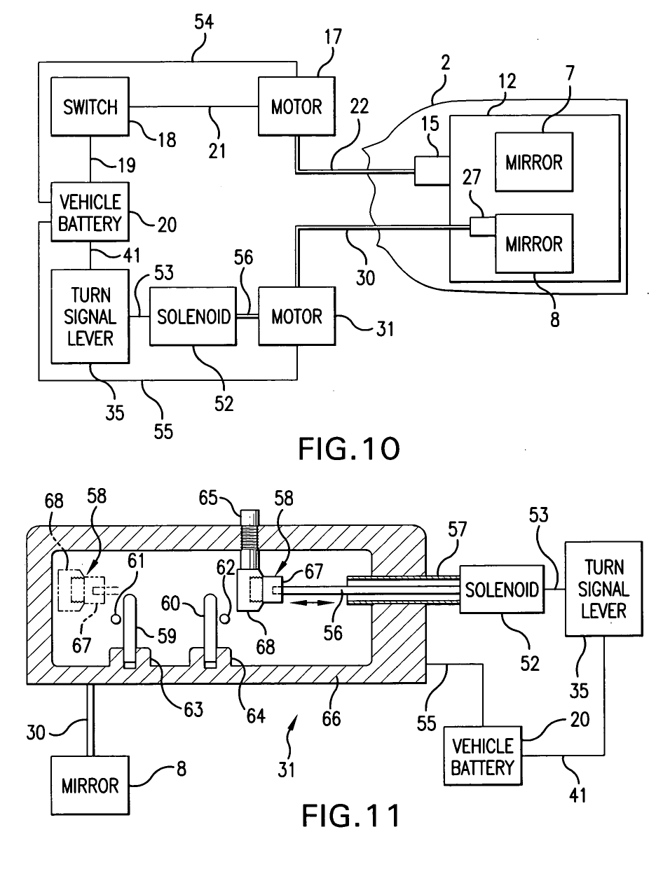

The subframe 12 includes a vertically extending mounting post 13 attached to the back face of the subframe. The post 13 has a toothed drive surfaced 14 for cooperating with a toothed drive gear 15. It is to be understood, however, that other drive surfaces, such as friction, are possible. The drive gear 15 is rotatably mounted in the mirror assembly 9 by way of the bearing supports 16, shown in FIG. 6. The drive gear 15 is connected to a first reversible electric motor 17, shown in FIG. 10. In FIG. 10, as in FIGS. 9 and 11, electrical connections between the parts are shown by a single line while mechanical connections by double lines. Rotation of the drive gear 15 against the drive surface 14 effects rotation of the subframe 12 about the vertical axis of the mounting post 13. This, in turn, causes both mirrors 7 and 8 to move in unison, while in the single plane shown in solid line of FIG. 4, to the driver's desired position for best viewing the viewing area 4.

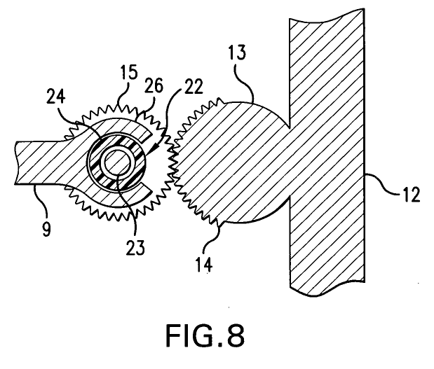

Adjustment of the mirrors 7 and 8 in unison to their desired set or home position is accomplished by the driver actuating a first switch 18 shown in FIG. 10 as electrically connected, via wire 19, to the vehicle's battery 20 and electrically connected to the first motor 17 via wire 21. The motor 17, in turn, is electrically connected to the vehicle battery 20 by the wire 54 and to the drive gear 15 by a conventional flexible drive cable 22. As shown in FIG. 6, this cable has an inner rotatable wire 23 drivingly connected to the drive gear 15. The outer cable housing 24 extends through an opening 25 in the assembly 9 and is secured at its drive end to the assembly 9 by the cable support 26 of the assembly 9. As shown in FIG. 8, the cable housing 24 of the drive cable 22 is mounted in the support 26 of the frame 9 by a snap fit, the assembly 9 being of plastic material to permit this type of fitting. Similarly, the bearing supports 16 for the drive gear 15 provide a snap fit. This facilitates assembly of the various parts of the mirror system and is used for other cable and drive gear supports.

The switch 18 for adjusting the mirror subframe 12 about the vertical axis of its mounting post 13 is typically a toggle type of button switch whereby movement in one direction causes the motor 17 to operate in one direction to, in turn, cause the drive gear 15 to rotate in one direction thereby rotating the subframe 12 and thus the mirrors 7 and 8 in this one direction. Movement of the switch 18 in the opposite direction causes the opposite movement of the motor 17, drive gear 15 and subframe 12 and thus the mirrors 7 and 8. With the above construction and control, the mirrors 7 and 8 are set by the driver in the normal set on home position to give the best view of area 4.

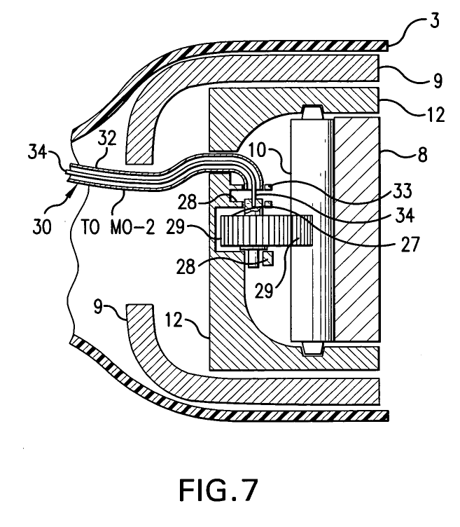

To permit rotation of the mirror 8 relative to mirror 7, a drive gear 27 (FIG. 7) is rotatably mounted in bearing supports 28 provided in the subframe 12. This mounting is a snap fit like that for drive gear 15. Drive gear 27 has a toothed surface engaging a toothed surface 29 on the mounting post 10 for the mirror 8. A flexible drive cable 30, like drive cable 22, is employed to connect drive gear 27 to a high speed, reversible electric motor 31 shown in FIGS. 9, 10 and 11. The motor 31 is electrically connected to the vehicle's battery 20 via the wire 55. As shown in FIG. 7, the outer housing 32 of the drive cable 30 is connected into the cable support 33 of the subframe 12 by a snap-fit like that for cable 22. The inner rotatable wire 34 of cable 30 is drivingly connected to the drive gear 27 to effect its rotation in either direction upon activation of motor 31. This will cycle mirror 8 back and forth between its home and extended positions shown in solid and dotted lines, respectively, in FIG. 4.

The control for actuating the drive motor 31 and thus the movement of mirror 8 is shown in FIGS. 9-15. In accordance with the preferred embodiment of the invention, this control is defined by the turn signal lever 35 which is part of the vehicle's turn signal mechanism. It is to be understood, however, that the control for the mirror 8 can be a stand-alone switch, separate from the turn signal mechanism.

As shown in FIGS. 9, 12 and 13, the vehicle's turn signal lever 35 is mounted for pivoting movement on a plastic support shaft 36 which, in turn, is rotatably mounted in the turn signal lever housing 37, which is also of plastic material. The shaft 36 has an octagonal cross-sectional shape complementary to the mounting opening 38 in the base 39 of turn signal lever 35. The lever is held in place on the shaft by the washers 40, placed between the lever base and housing. In the embodiment shown in FIG. 9, the lever base 39 is constructed of conductive material and connected to the electrical power of the vehicle's battery 20 by way of the wire 41. The left and right turn signal flashers 42, 42′, respectively, have one electrical side connected to the vehicle's battery 20 by wires 43, 43′, respectively, and the other electrical side connected, via wires 44, 44′, to the electrical contacts 45, 45′, respectively. In this way, movement of the turn signal lever 35 down or up from a first standby position A shown in solid lines in FIG. 9 to either position C or C′, shown in phantom in FIG. 9, will cause the conductive base 39 of the turn signal lever to make contact with either the contact 45 or 45′. This will complete the electrical circuit, via wires 44, 44′, between the battery 20 and the particular turn signal flasher 42 or 42′ causing it to operate. It is, of course, understood that the turn signal flasher here referred to includes the front and rear lights and/or other lights used for indicating a vehicle turn to the left or right.

In FIG. 9, the mirror and turn signal parts where they relate to a right turn of the vehicle are shown using the same reference numbers as used for the left turn, but followed by the prime sign. Also in FIG. 9, the normal standby position A of the turn signal lever, is shown in solid lines and various positions of activation B, C, D, B′, C′, D′ are shown, for clarity, in spaced phantom. In position C or C′ the lever base 39 has made engagement with the electrical contact 45 or 45′, but in this position the driver must continue to hold the lever or it will automatically return to its standby position A. As conventional in most vehicles, including the test vehicle mentioned above, continued movement of the turn signal lever 35 through a further segment of pivoting or angular movement from position C or C′ to position D or D′ maintains the electrical circuit between the battery 20 and flasher 42, 42′, but in position D or D′, the driver need not hold the lever at all to maintain flasher activation.

The construction of the contact 45 is shown in detail in FIG. 14. It includes a conductive button 46 mounted in the housing 37 and urged upwardly, by compression spring 47, into the path of movement of the conductive base 39 of the turn signal lever. The button 46 is electrically connected to the flasher 42 via the wire 44. As shown in FIG. 15 the bottom of the lever base has a chamfered surface 48 in its handle segment which connects the base to the plastic handle end 49. This chamfered surface 48 permits proper engagement of the handle segment of the base 39 with the button 46 as the turn signal lever is moved from its initial contact with the button in position C and continued overriding contact in position D.

As also conventional in present day vehicles, the turn signal lever 35 returns automatically from position D or D′ to its standby position A when the vehicle has completed its indicated turn. Alternatively, the lever can be moved manually back to position A. For facilitating return movement of the turn signal lever to its standby position, two tension springs 50, 50′ are provided. As shown in FIG. 13, these springs are wrapped part way around the lever base 39 and secured at one end to the lever base and at their other ends to the lever housing 37. Spring 50 will be put in operation when the lever is pivoted for showing a left turn while the spring 50′ will function to return the lever after a right turn. As an alternative to the button construction of switch 45, a toggle type switch, not shown, can be employed. In such a construction, engagement of the switch 45 caused by movement of the turn signal lever 35 in one direction will operate the toggle switch in one direction to activate the turn signal flasher. The return movement of the turn signal lever will move the toggle switch in the other direction to turn off the turn signal flasher.

As most clearly shown in FIGS. 9-11, the control for the driver's side mirror 8 includes an electrical contact 51 of the same construction as contact 45. Upon movement of the turn signal lever 35 through a first segment of angular movement from the standby position shown at A in FIG. 9 to the B position, the handle portion of the lever base 39 makes initial engagement with the contact 51. This, in turn, will activate the mirror 8, as more fully described below. This initial engagement with contact 51 will occur before engagement with contact 45 which initiates operation of the turn signal flasher 42. Accordingly, the driver has the ability to cycle the mirror 8 to its extended position so as to view the blind area 11 and back to its home position without signaling a lane change. If, however, a lane change appears appropriate, the driver can then further move the turn signal lever 35 past position B and through another segment of angular movement to position C to initiate actuation of the turn signal flasher 42. If the adjacent lane is still clear, the turn signal lever 35 can be moved further from position C through a final segment of angular movement to position D. After changing lanes, the turn signal lever will automatically return to its standby position A. Of course, the lever can be manually moved back to position A at any point in its use. Return to the A position not only turns off the turn signal flasher but, as described below, cycles the mirror 8 back to its home position.

The contact 51 for the mirror 8 is electrically connected to a solenoid 52 via wire 53. The solenoid is, in turn, connected to the high speed electric motor 31 for the mirror 8 by way of its reciprocating solenoid rod 56. As shown in FIG. 11, the rod is slidably mounted in rod housing 57, the outer end of which is secured to the housing 66 for the motor 31. Energization of the solenoid causes its rod 56 to move from the neutral position shown in solid lines in FIG. 11 to the extended position shown in phantom. The free end of the rod 56 has a contact member 58 for engaging the flexible forward and reverse switch levers 59, 60, respectively. The levers 59, 60 are provided for engaging actuating contacts 61, 62 of the motor 31. Engagement of contact 61 causes forward motion of the motor 31 to cycle mirror 8 to its extended position and engagement of contact 62 causes reverse motion of motor 31 to cycle mirror 8 back to its home position. As shown in FIG. 11, the levers 59, 60 are normally secured by mountings 63, 64 of the motor housing 66 in an upright position out of engagement with contacts 61, 62.

Movement of the rod 56 to its extended position causes rod contact member 58 to engage switch lever 60 and flex or pivot it in its mounting 64 in a counterclockwise direction and away from reverse actuating contact 62. As the contact member 58 passes contact lever 60, the lever flexes back to its normal upright position still out of engagement with contact 62.

Continued extending movement of the rod 56 next causes rod contact 58 to engage switch lever 59 for a period of time as it pivots or flexes lever 59 to move the lever into engagement with contact 61. This engagement is maintained until the lever 59 flexes sufficiently to permit the rod contact 58 to move past the lever and into its final extended position shown in phantom in FIG. 11. Engagement of the switch lever 59 with the actuating contact 61 of the motor 31 cause the motor to run for a period of time to thereby rotate wire 34 (FIG. 7) of drive cable 30 connected to the motor 31 in one direction. This, in turn, rotates drive gear 27 in a direction causing rotation of the mounting post 10 of the mirror 8 in a clockwise direction, as viewed in FIG. 4, to cycle mirror 8 to its extended position.

When the turn signal lever 35 is moved to disengage from electrical contact 51, the electrical current to the solenoid is cut off and the solenoid rod 56 retracts to its neutral solid line position shown in FIG. 11. This causes rod contact 58 to first engage switch lever 59 and flex it in a clockwise direction away from actuating contact 61. Once the rod contact 58 moves past the switch lever 59, the lever returns to its normal upright position. Thus, no further forward movement of mirror 8 occurs. Next, however, the rod contact 58 engages switch lever 60 for a period of time and causes it to rotate in the clockwise direction to engage activating contact 62 of motor 31 for a period of time. This causes reverse operation of the motor 31 and reverse rotation of wire 34 of the drive cable. This, in turn, rotates drive gear 27 in a reverse direction causing reverse rotation of the mounting post 10 to cycle mirror 8 back to its home position. Once the rod contact 58 moves past lever 60, the lever flexes back to its normal upright position. It is to be understood that the extent of reverse rotation of the drive gear 27 will equal the extent of its forward rotation so that the mirror 8 will return to the set home position.

In some present day vehicles, including the test vehicle described above, the passenger side rearview mirror includes a drive mechanism for tilting the mirror to a downwardly facing position so that the area of the ground adjacent the passenger side of the car is viewable, This is provided for assisting the driver in parallel parking the vehicle adjacent the curb of the road. The actuation of the drive mechanism to tilt the mirror from its normal set position to the downwardly facing position is automatically initiated when the vehicle is put into reverse gear. Movement back precisely to the set position occurs automatically when the vehicle is taken out of reverse gear. This same type of drive mechanism, modified as described below to provide the necessary speed of operation, may be employed in the present invention for cycling the mirror 8 between its home and extended positions.

As previously indicated, the motor 31 is preferably a high speed reversible motor. More particularly, it is of the same construction as the motor system used in today's vehicles, including the test vehicle described above, except that it is designed for higher speed operation so as to effectively cycle the mirror 8 between its home and extended position at a speed permitting immediate viewing of the blind area. The motor 31 can be a single reversible motor or a pair of motors, one for forward movement and one for reverse movement, as desired. The high speed can be accomplished by design of the motor or motors, or the conventional motor or motors can be directly connected via drive cable 30 to a drive gear 27 appropriately sized relative to the toothed surface 29 of the mounting post 10 to produce the desired speed of movement of the mirror 8.

As shown in FIG. 11, the engagement of the levers 59, 60 with their cooperating actuating contacts 61, 62 is only momentary as the solenoid rod 56 is extended and retracted. The resulting connection of the contacts 61, 62 into the electrical circuitry of the motor 31 is sufficiently long enough to actuate the motor 31 for the increment of time necessary to effect the desired angular movement of the mirror 8 to cycle it to the extended position. Adjustment of this increment of time can be made by varying the lateral thickness of the rod contact 58 as measured in the direction of the axis of the rod 56. This will vary the engagement time of the rod contact 58 with the levers 59, 60 as they flex initially to engage the contacts 61, 62 and flex further to permit the rod contact 58 to pass by the levers 59, 60. The angular movement of mirror 8 about the axis of its support post 10 will vary with different models of vehicles. With the test vehicle referred to above the angular movement was measured to be about 20°. Accordingly, for such a vehicle, the lateral thickness of the rod contact 58 will be such as to produce the necessary time of operation of the motor 31.

Adjustment of the rod contact thickness can be provided by permitting access to the interior of the motor 31 and replacement of one sized contact with another. Alternatively, with the motor 31 being mounted in the driver's side door or arm rest, an adjustment control for the rod contact 58 is provided for direct setting by the driver. This control is shown in FIG. 11 as a knurled wheel 65 rotatably mounted in the motor housing 66 and having a segment of the wheel exposed for rotation by the driver. The rod contact 58 is shown in FIG. 11 as comprising telescoping cylindrical parts 67, 68, threadedly coupled together. Part 67 is connected to the solenoid rod 56 and part 68 is threadedly received on the free end of part 67. The knurled wheel is threadedly mounted in the motor housing 66 with its lower end in frictional engagement with the peripheral surface of the part 68 when the solenoid, and more particularly the rod contact 58, is in its neutral position as shown by the solid lines in FIG. 11. Rotation of the knurled control wheel in one or an opposite direction will cause corresponding rotation of the part 68 on the part 67. This, in turn, will change the lateral width of the rod contact 58 and thus adjustment of the motor operation time, as explained above.

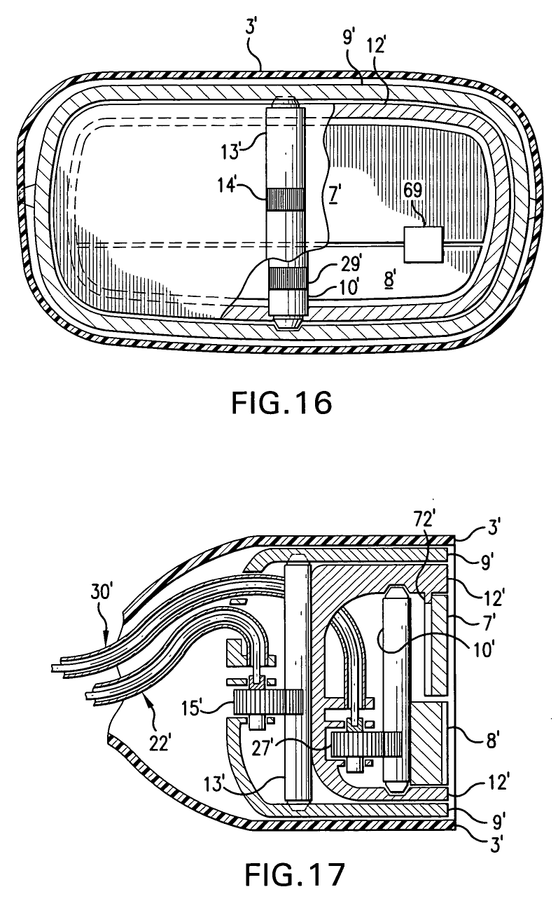

In the embodiment of the invention shown and described with reference to FIGS. 1-15, the mirror 8 for viewing the blind area is mounted laterally or horizontally outwardly of the mirror 7. Alternatively, the mirror for the blind area may be mounted immediately above or below the standard mirror. Such a construction is shown in FIGS. 16 and 17 where mirror 8 is positioned directly below mirror 7. Like parts of this embodiment to the parts of the embodiment of FIGS. 1-15 are represented by the same reference numbers followed by the prime sign. An added element of this embodiment includes the stop 69 provided on the back of mirror 8′ to assure that its home position is lined up in the same plane with mirror 7′. In the first embodiment, this is accomplished by engagement of the chamfered ends of the mirrors 7 and 8.

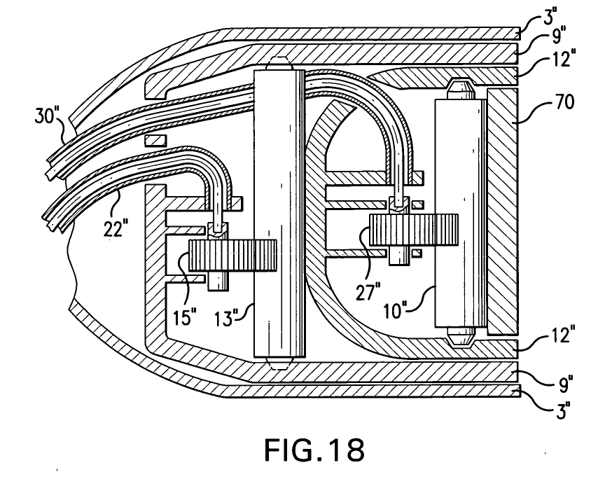

A third embodiment of the invention is shown in FIG. 18. Here like parts to the parts of the embodiment of FIGS. 1-15 are identified by the same reference numbers followed by the double prime sign. In this embodiment a single sweep mirror 70 is provided. From outward appearances this mirror looks like the standard side mounted rearview mirror of present day vehicles. Internally, however, mirror 70 is connected to two motor drives. The first drive 15″, 22″ connects to the motor 17 of FIG. 10 for making the normal lateral adjustments of the mirror 70 to suit the driver's view of the normal viewing area 4. In addition, the second drive 27″, 30″ connects to the high speed motor 31 of FIG. 10 to permit high speed cycling of the entire mirror 70 between home and extended positions in the same way as done for mirrors 8 and 8′ of the earlier embodiments.

In both the second and third embodiments, the corresponding mirror assembly 9′, 9″ is also mounted for adjustment about a horizontal axis in the same way as in the embodiment of FIGS. 1-15. Further, the control for activating the drive mechanism for mirror 8′ and mirror 70 is defined by the turn signal lever and associated mechanisms shown in FIG. 9. With the construction of FIG. 18, the driver can get an immediate view of the blind area 11 using the entire mirror 70.

As mentioned above, movement of the mirrors 8, 8′ or 70 to their extended position may include pivoting about a horizontal axis as well as a vertical axis. This can easily be accomplished by providing an additional high speed drive mechanism, operable through contacts 51, 51′, for rotating the assembly 9, 9′, 9″ about its mounting posts. Alternatively, a single two-speed drive mechanism can be provided, with the low speed operated by the normal control adjustment switch 17 and the high speed adjustment by the turn signal lever 35. Furthermore, although the mirrors 8, 8′ and 70 are shown as side mounted mirrors, they could be constructed for mounting at the top center of the windshield. This type of mirror is usually manually adjustable through a universal mounting joint for the frame in which the mirror is positioned. With such a construction, the center of the mirror can be fixedly mounted in the frame and the left and right ends mounted for high speed movement by way of the drives used in the embodiments shown in the drawings, the left end for left turns and the right end for right turns. Alternatively, the mirror can be divided into two parts, one being the left end and the other being the right end of the mirror. Again, the left end would be used for left turns and the right end for right turns. Finally, a single mirror, like that of mirror 70 can be employed with a reversible high speed drive motor or with one drive motor for moving the entire mirror in one direction for left turns and another drive motor for right turns.

As another modification not specifically shown, an on/off switch can be provided, as for example, in lines 53, 53′, to deactivate the drive mechanism for moving the mirrors 8, 8′ or 70 to the extended position.

Although the present invention has been described in relation to particular embodiments, it is to be understood that the various changes thereto can be made without departing from the spirit and scope of the invention as defined in the following claims.

I claim:

1. A vehicle rearview mirror system comprising:
a) a first rearview mirror for mounting on a first vehicle in a location for a driver of said first vehicle to see, by means of said first mirror, a first area behind said vehicle, said first mirror creating a blind spot, said blind spot being a second area where a second vehicle passing said first vehicle moves out of said driver's viewing in said first mirror until said second vehicle can be seen directly by said driver when nearly broadside of said first vehicle; and
b) a second sweep mirror for mounting on said first vehicle adjacent to said first mirror, said sweep mirror providing said driver alternately with a view of the first area and the second area of the blind spot of said first mirror.

2. A vehicle rearview mirror system according to claim 1, wherein:
a) said first and sweep mirrors are contained in a single rearview mirror assembly for mounting on said first vehicle.

3. A vehicle rearview mirror system according to claim 2, wherein
a) said sweep mirror is movably positioned in said mirror assembly immediately adjacent to said first mirror for movement relative to said first mirror between a home position and an extended position;
b) said first and sweep mirrors both provide said driver with a view of said first area when mounted on said first vehicle and when said sweep mirror is in said home position; and
c) said sweep mirror provides said driver with a view of the second area of the blind spot of said first mirror when moved from said home position to said extended position.

4. A vehicle rearview mirror system according to claim 3, further including:
a) a drive mechanism connected to said sweep mirror for moving said sweep mirror between said home and extended positions;
b) a control operable by said driver for activating said drive mechanism.

5. A vehicle rearview mirror system according to claim 4, wherein:
a) said sweep mirror is mounted for movement about a vertical axis; and
b) said drive mechanism is a reversible electric motor for cycling said sweep mirror about said vertical axis from said home position to said extended position and back to said home position.

6. A vehicle rearview mirror system according to claim 5, wherein:
a) said reversible motor cycles said sweep mirror from said home position to said extended position, when activated by said control, at a speed permitting immediate viewing of said second area.

7. A vehicle rearview mirror system according to claim 6, wherein:
a) said reversible motor cycles said sweep mirror from said home position to said extended position in about a second or less.

8. A vehicle rearview mirror system according to claim 5, wherein:
a) said control is a turn signal lever provided in said first vehicle for movement by the driver through an angle of movement from a standby position to an activated position to effect operation of a turn signal flasher causing flashing of vehicle lights to indicate turning of said first vehicle, movement of said lever to said activated position further effecting activation of said drive mechanism to cycle said sweep mirror from said home position to said extended position.

9. A vehicle rearview mirror system according to claim 8, wherein:
a) said sweep mirror, once cycled to said extended position, remains in said extended position as long as said turn signal lever is in said activated position and cycles back to said home position when said turn signal lever moves back to its standby position.

10. A vehicle rearview mirror system according to claim 9, wherein said turn signal lever is movable through an angle of movement having four positions of operation, including:
a) a first position being said standby position where the lever is normally located and where said sweep mirror is in said home position and the turn signal flasher is inactive;
b) a second activated position where the lever is moved through a first segment of said angle of movement to activate said drive mechanism to cycle said sweep mirror from said home position to said extended position without activating said turn signal flasher; c) a third activated position where the lever is moved further past said first segment and through a second segment of said angle of movement to activate said turn signal flashers as long as said lever is held by said driver in said third position, said lever maintaining activation of said drive mechanism in said third position to maintain said sweep mirror in said extended position; and
d) a fourth activated position where the lever is moved further past the second segment of said angle of movement to activate said turn signal flasher without requiring the driver to hold the lever, said lever maintaining activation of said drive mechanism in said fourth position to maintain said sweep mirror in said extended position.

11. A vehicle rearview mirror system according to claim 10, wherein:
a) said sweep mirror is mounted horizontally adjacent to said first mirror and laterally outwardly thereof relative to said vehicle.

12. A vehicle rearview mirror system according to claim 10, wherein:
a) said sweep mirror is mounted vertically adjacent and below said first mirror.

13. A vehicle rearview mirror system comprising:
a) a rearview sweep mirror for mounting on a first vehicle in a location for a driver of said first vehicle to see by means of said mirror, when in a first home position, a first area behind said vehicle, said mirror when in said first home position creating a blind spot, said blind spot being a second area where a second vehicle passing said first vehicle moves out of said driver's viewing in said mirror until said second vehicle can be seen directly by said driver when nearly broadside of said first vehicle;
b) a drive mechanism connected to said sweep mirror for moving said mirror between said first home position and a second extended position providing said driver a view of the second area of the blind spot of said mirror, said drive mechanism being a reversible electric motor for cycling said mirror from said home position to said extended position and back to said home position;
c) a control operable by said driver for activating said drive mechanism; and
d) said reversible motor cycles said sweep mirror from said home position to said extended position, when activated by said control, at a speed giving immediate viewing of said second area.

14. A vehicle rearview mirror system according to claim 13, wherein:
a) said reversible motor cycles said sweep mirror from said home position to said extended position in about a second or less.

15. A vehicle rearview mirror system comprising:
a) a rearview sweep mirror for mounting on first vehicle in a location for a driver of said first vehicle to see by means of said mirror, when in a first home position, a first area behind said vehicle, said mirror when in said first home position creating a blind spot, said blind spot being a second area where a second vehicle passing said first vehicle moves out of said driver's viewing in said mirror until said second vehicle can be seen directly by said driver when nearly broadside of said first vehicle;
b) a drive mechanism connected to said sweep mirror for moving said mirror between said first home position and a second extended position providing said driver a view of the second area of the blind spot of said mirror, said drive mechanism being a reversible electric motor for cycling said mirror from said home position to said extended position and back to said home position; and
c) a control operable by said driver for activating said drive mechanism, said control being a turn signal lever provided in said first vehicle for movement by the driver through an angle of movement from a standby position to an activated position to effect operation of a turn signal flasher causing flashing of vehicle lights to indicate turning of said first vehicle, movement of said lever to said activated position further effecting activation of said drive mechanism to cycle said sweep mirror from said home position to said extended position.

16. A vehicle rearview mirror system according to claim 16, wherein:
a) said reversible motor cycles said sweep mirror from said home position to said extended position in about a second or less.

17. A vehicle rearview mirror system according to claim 16, wherein:
a) said sweep mirror, once cycled to said extended position, remains in said extended position as long as said turn signal lever is in said activated position and cycles back to said home position when said turn signal lever moves back to its standby position.

18. A vehicle system according to claim 17, wherein:
a) said sweep mirror is mounted for movement about a vertical axis; and
b) said reversible electric motor cycles said mirror about said vertical axis from said home position to said extended position and back to said home position.

19. A vehicle mirror system according to claim 18 wherein said turn signal lever is movable through an angle of movement having four positions of operation including;
a) a first position being said standby position where the lever is normally located and where said sweep mirror is in said home position and the turn signal flasher is inactive;
b) a second activated position where the lever is moved through a first segment of said angle of movement to activate said drive mechanism to cycle said mirror from said home position to said extended position without activating said turn signal flasher;
c) a third activated position where the lever is moved further past said first segment and through a second segment of said angle of movement to activate said turn signal flasher as long as said lever is held by said driver in said third position, said lever maintaining activation of said drive mechanism in said third position to maintain said mirror in said extended position; and
d) a fourth activated position where the lever is moved further past the second segment of said angle of movement to activate said turn signal flasher without requiring the driver to hold the lever, said lever maintaining activation of said drive mechanism in said fourth position to maintain said mirror in said extended position.

20. A vehicle rearview mirror system according to claim 19, wherein:
a) one of said sweep mirrors in included for mounting on each of the left driver's side and the right passenger side of said first vehicle; and
b) said turn signal lever operates the sweep mirror on the driver's side of the vehicle when moved to indicate turning left and operates the sweep mirror on the passenger side of the vehicle when moved to indicate turning right.
